(19) United States
(12) Patent Application Publication
(10) Pub. No.: US 2026/0317182 A1
(43) Pub. Date: Oct. 15, 2026

(54) METHODS FOR MAKING MFI/TON-TYPE ZEOLITE INTERGROWTH STRUCTURES

(71) Applicant: PURDUE RESEARCH FOUNDATION, West Lafayette, IN (US)

(72) Inventors: Rajamani P. Gounder, West Lafayette, IN (US); Soonhyoung Kwon, Carmel, IN (US)

(21) Appl. No.: 19/644,156

(22) Filed: Apr. 10, 2026

Related U.S. Application Data
(60) Provisional application No. 63/786,990, filed on Apr. 11, 2025.

(51) Int. Cl. C01B 39/02; C01B 39/04

(52) U.S. Cl. CPC C01B 39/023; C01B 39/04; C01P 2002/72; C01P 2002/85; C01P 2004/03; C01P 2004/04; C01P 2006/16

(57) ABSTRACT

New synthesis methods for MFI/TON-type zeolite intergrowth structures that result in zeolites having different material properties, including channel topology, average pore size, crystallite size, crystallite morphology, and Si/Al ratio. The structures can be synthesized from a precursor gel comprising two or more structure-directing agent (SDAs) selected from the group consisting of ethylenediamine (EDA), diethylamine (DEA), tetrapropylammonium (TPA⁺), n-propylamine (NPAM), 1,4-diaminobutane (DAB), 1,6-diaminohexane (DAH), and combinations thereof, optionally, sodium cations (Na⁺); optionally, potassium cations (K⁺); a source of silicon (Si); and a source of aluminum (Al).

### GOVERNMENT LICENSE RIGHTS

This invention was made with government support under Cooperative Agreement No. EEC-1647722 awarded by the National Science Foundation. The government has certain rights in the invention.

### BACKGROUND

### Field of the Invention

Embodiments provided herein relate to zeolites and zeotypes. More particularly, embodiments provided herein relate to MFI/TON-type zeolite intergrowth structures and methods for making the same.

### Description of the Related Art

Zeolites are crystalline microporous aluminosilicates that are widely used as acid catalysts in the petrochemical and refining industries to convert carbon feedstocks to chemicals and fuels, because they provide control over reaction networks (e.g., via shape selectivity and confinement effects) that arise from differences in crystal framework topology (i.e., pore size and connectivity) and crystallite size.

Zeolites contain tetrahedral silicon atoms linked by oxygen, forming charge-neutral crystalline structures. Substitution of Si by Al provides a negative charge in the lattice, which is compensated by cations. When the cation is a proton, strong Brønsted acid sites are created, which can be used in catalytic transformations, like cracking, oligomerization, and many other reactions.

Zeolites can be synthesized with varying crystallite sizes and morphologies, with smaller crystallites leading to shorter diffusion pathlengths. Zeotypes are zeolite-like materials that include other elements in addition to silicon, aluminum, and oxygen.

A common type of zeolite is a zeolite with MFI framework topology. MFI zeolites are most often synthesized using an aqueous basic solution of silica, alumina and structure-directing agents (SDA), often with tetrapropylammonium as the primary organic SDA (OSDA) and optionally with Na⁺ as a co-SDA.

Zeolites with the MFI framework topology provide shape-selective properties that are particularly useful for the conversion of methanol-to-olefins, gasoline, and hydrocarbons (MTO, MTG, MTH), and are particularly useful for the selective cracking of linear paraffins that allows its use as an additive to fluid catalytic cracking catalysts (i.e., FAU-type zeolites) to produce gasoline with higher octane rating.

TON-type zeolites are another family of crystalline microporous solids. TON-type zeolites are also known as molecular sieves or mole sieves, and can be characterized by one-dimensional channels with elliptical 10-membered ring windows. TON-type zeolites are typically used as adsorbents in gas separations processes or as catalysts in various chemical reactions.

Zeolites are also useful for olefin oligomerization reactions to gasoline and distillate fuels, among other processes. Light olefin oligomerization is a promising pathway to produce higher molecular weight hydrocarbons for transportation fuels. Solid acids including supported phosphoric acid, acid resins, amorphous silica-alumina, and zeolites have been used in industrial oligomerization processes, with MFI zeolites garnering the most attention for these reactions due to their resistance to coke formation and high selectivity to linear olefins.

There is a still a need, however, for new catalysts with greater selectivity and better overall performance.

### SUMMARY

A method for making MFI zeolites containing TON-type intergrowths and the resulting MFI/TON-intergrowth zeolite structures are provided. In at least one embodiment, the MFI/TON-type zeolite intergrowth structures can be synthesized from a precursor gel comprising two or more structure-directing agent (SDAs) selected from the group consisting of ethylenediamine (EDA), diethylamine (DEA), tetrapropylammonium (TPA+), n-propylamine (NPAM), 1,4-diaminobutane (DAB), 1,6-diaminohexane (DAH), and combinations thereof, optionally, sodium cations (Na⁺); optionally, potassium cations (K⁺); a source of silicon (Si); and a source of aluminum (Al).

In at least one embodiment, an MFI/TON-type zeolite intergrowth structure made from an aluminosilicate gel is also provided. The aluminosilicate gel comprising two or more structure-directing agent (SDAs) selected from the group consisting of ethylenediamine (EDA), diethylamine (DEA), tetrapropylammonium (TPA+), n-propylamine (NPAM), 1,4-diaminobutane (DAB), 1,6-diaminohexane (DAH), and combinations thereof, optionally, sodium cations (Na+); optionally, potassium cations (K⁺); a source of silicon (Si); and a source of aluminum (Al).

One particular method for making the MFI/TON-intergrowth zeolite structures comprises preparing an aqueous solution comprising two or more structure directing agents selected from the group consisting of ethylenediamine (EDA), diethylamine (DEA), tetrapropylammonium (TPA+), n-propylamine (NPAM), 1,4-diaminobutane (DAB), 1,6-diaminohexane (DAH), and combinations thereof, mixing the aqueous solution with at least one silicon precursor and at least one aluminum precursor to provide a precursor gel; and recovering MFI/TON-type zeolite intergrowth structures from the precursor gel, wherein the MFI/TON-type zeolite intergrowth structures are crystalline solids having a crystallite size of about 0.001 μm to about 10 μm.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are, therefore, not to be considered limiting of its scope, for the invention may admit to other equally effective embodiments. It is emphasized that the figures are not necessarily to scale and certain features and certain views of the figures can be shown exaggerated in scale or in schematic for clarity and/or conciseness.

FIG. 1A shows a powder X-ray diffraction (pXRD) of a calcined zeolite sample (SHK1-9-1-1), synthesized with a precursor gel Si/Al ratio of 191 from tetrapropylammonium (TPA⁺) and diethylamine (DEA).

FIG. 1B shows a powder X-ray diffraction (pXRD) of a calcined zeolite sample (SHK1-9-2-1), synthesized with a precursor gel Si/Al ratio of 95 from tetrapropylammonium (TPA⁺) and diethylamine (DEA).

FIG. 2 shows pXRD patterns of four different MFI/TON intergrowth structure samples (SHK1-9-1-1, SHK1-9-2-1, SHK1-36-1, and SHK1-36-2) synthesized with varying precursor gel compositions.

FIG. 3 shows pXRD patterns of six different MFI/TON intergrowth structure samples (SHK1-36-8, SHK1-36-7, SHK1-36-6, SHK1-36-5, SHK1-9-2-1, and SHK1-36-2) synthesized with different DEA/TPA⁺ ratios, ranging from 0.5 to 14.5.

FIG. 4 shows a pXRD pattern of a sample (SHK1-40-7) synthesized with a precursor gel Si/Al ratio of 47 from ethylenediamine (EDA) and diethylamine (DEA).

FIG. 5 shows pXRD patterns of samples synthesized with the same EDA/DEA ratios in the presence of different sodium and potassium environments.

FIG. 6A shows a scanning electron microscope (SEM) image of a calcined sample (SHK1-9-1-1) synthesized with a precursor gel Si/Al ratio of 191 from tetrapropylammonium (TPA⁺) and diethylamine (DEA).

FIG. 6B shows a transmission electron microscopy (TEM) image of the sonicated sample SHK1-9-1-1.

FIG. 7A shows an SEM image of the sample SHK1-9-1-1.

FIG. 7B shows a focused ion-beam (“FIB”) cross-sectional image of the sample SHK1-9-1-1.

FIG. 8A shows an SEM image of the sample SHK1-9-1-1.

FIG. 8B shows an electron diffraction spectroscopy (“EDS”) analysis of oxygen, silicon, aluminum and platinum (platinum was sputtered before measuring the microscopy image) of the same region.

FIG. 9A shows an integrated differential phase contrast (iDPC) scanning transmission electron microscopy (STEM) image of the calcined sample SHK1-9-1-1.

FIG. 9B shows MFI and TON structures superimposed for visualization.

FIG. 10 is an SEM image of sample SHK1-42-7 synthesized with EDA and DEA.

### DETAILED DESCRIPTION

It is to be understood that the following disclosure describes several exemplary embodiments for implementing different features, structures, or functions of the invention. Exemplary embodiments of components, arrangements, and configurations are described below to simplify the present disclosure; however, these exemplary embodiments are provided merely as examples and are not intended to limit the scope of the invention. Additionally, the present disclosure can repeat reference numerals and/or letters in the various embodiments and across the figures provided herein. This repetition is for the purpose of simplicity and clarity and does not in itself dictate a relationship between the various embodiments and/or configurations. Moreover, the exemplary embodiments presented below can be combined in any combination of ways, i.e., any element from one exemplary embodiment can be used in any other exemplary embodiment, without departing from the scope of the disclosure.

Additionally, certain terms are used throughout the following description and claims to refer to particular components. As one skilled in the art will appreciate, various entities can refer to the same component by different names, and as such, the naming convention for the elements described herein is not intended to limit the scope of the invention, unless otherwise specifically defined herein. Further, the naming convention used herein is not intended to distinguish between components that differ in name but not function.

Furthermore, in the following discussion and in the claims, the terms “including” and “comprising” are used in an open-ended fashion, and thus should be interpreted to mean “including, but not limited to.” The phrase “consisting essentially of” means that the described/claimed composition does not include any other components that will materially alter its properties by any more than 5% of that property, and in any case does not include any other component to a level greater than 3 mass %.

Unless otherwise indicated, all numerical values are “about” or “approximately” the indicated value, meaning the values take into account experimental error, machine tolerances and other variations that would be expected by a person having ordinary skill in the art. It should also be understood that the precise numerical values used in the specification and claims constitute specific embodiments. Efforts have been made to ensure the accuracy of the data in the examples. However, it should be understood that any measured data inherently contains a certain level of error due to the limitation of the technique and/or equipment used for making the measurement.

The term “or” is intended to encompass both exclusive and inclusive cases, i.e., “A or B” is intended to be synonymous with “at least one of A and B,” unless otherwise expressly specified herein.

The indefinite articles “a” and “an” refer to both singular forms (i.e., “one”) and plural referents (i.e., one or more) unless the context clearly dictates otherwise. For example, embodiments using “an olefin” include embodiments where one, two, or more olefins are used, unless specified to the contrary or the context clearly indicates that only one olefin is used.

The term “oligomerization” refers to the formation of an oligomer from molecules of lower relative molecular mass. The term “oligomer” refers to dimers, trimers, tetramers, and other molecular complexes having less than 26 repeating units. Oligomers provided herein are typically gases or liquids at ambient temperature, and can include low melting solids, including waxes, at ambient temperature. In some embodiments, the oligomers provided herein can have an atomic weight or molecular weight of less than 10,000 AMU (Da), such as about 5,000 or less, 1,000 or less, 500 or less, 400 or less, 300 or less, or 200 or less. The molecular weight of the oligomer, for example, can range from a low of about 50, 250 or 350 to a high of about 500, 3,000, 7,000, or 9,000 AMU (Da).

The terms “alkane” and “paraffin” both refer to any saturated molecule containing hydrogen and carbon atoms only, in which all the carbon-carbon bonds are single bonds and are saturated with hydrogen. Such saturated molecules can be linear, branched, and/or cyclic.

The terms “alkene” and “olefin” both refer to any unsaturated molecule containing hydrogen and carbon atoms only, in which one or more pairs of carbon atoms are linked by a double bond. Such unsaturated molecules can be linear, branched, or cyclic, and can include one, two, three or more pairs of carbon atoms linked by double bounds (i.e. mono-olefins, di-olefins, tri-olefins, etc).

The term “wt %” means percentage by weight, “vol %” means percentage by volume, “mol %” means percentage by mole, “ppm” means parts per million, and “ppm wt” and “ppmw” are used interchangeably and mean parts per million on a weight basis. All concentrations herein, unless otherwise stated, are expressed on the basis of the total amount of the composition in question.

Each of the appended claims defines a separate invention, which for infringement purposes is recognized as including equivalents to the various elements or limitations specified in the claims. Depending on the context, all references to the “invention” may in some cases refer to certain specific embodiments only. In other cases, it will be recognized that references to the “invention” will refer to subject matter recited in one or more, but not necessarily all, of the claims. Each of the inventions will now be described in greater detail below, including specific embodiments, versions and examples, but the inventions are not limited to these embodiments, versions or examples, which are included to enable a person having ordinary skill in the art to make and use the inventions, when the information in this disclosure is combined with publicly available information and technology.

It has been surprisingly discovered that a new synthesis method for making MFI/TON-type zeolite intergrowth structures can result in different material properties (e.g., channel topology, morphology, crystallite defect/intergrowth regions, Al and acid site proximity). More particularly, it has been surprisingly discovered that two organic structure directing agents (“SDAs”) can act as co-templating agents to form an MFI/TON-type zeolite intergrowth structure that merges the intrinsic properties of the individual topologies-MFI's well-defined three-dimensional pore structure and TON's distinctive one-dimensional channel architecture-into a single, hierarchically organized material. By achieving precise control over intergrowth interfaces, pore connectivity can be tailored, resulting in catalysts that offer enhanced selectivity, improved diffusion properties, and longer lifetimes.

In one or more embodiments, the MFI/TON-type zeolite intergrowth structures can be synthesized using conventional techniques for synthesizing MFI (ZSM-5) zeolites, except that one or more structure-directing agent (SDAs) and/or one or more organic structure-directing agents (OSDA) and/or one or more inorganic structure-directing agents (ISDA) are also used. Suitable OSDAs can include ethylenediamine (EDA), diethylamine (DEA), tetrapropylammonium (TPA⁺), n-propylamine (NPAM), 1,4-diaminobutane (DAB), 1,6-diaminohexane (DAH), and combinations thereof. Suitable organoammonium compounds have 12 or less carbon centers along the length of the molecule. In certain embodiments, suitable organoammonium compounds have less than 7, less than 6, less than 4, or less than 3 carbon centers along the length of the molecule. For example, suitable organoammonium compounds include, but are not limited to, tetrapropylammonium hydroxide (TPAOH) or N-butyl-N-methylpyrrolidinium hydroxide (BMPAOH), and combinations thereof. Suitable ISDAs can include sodium (Na⁺), potassium (K⁺), and combinations thereof.

In at least one particular embodiment, the MFI/TON-type zeolite intergrowth structures can be synthesized by adding one or more structure-directing agents (SDAs) and/or one or more organic structure-directing agents (OSDA) and optionally one or more inorganic structure-directing agents (ISDA) to water to form an aqueous solution; homogenizing the aqueous solution for a first time period; adding a source of aluminum to the homogenized aqueous solution to form an intermediate agent and homogenizing the intermediate agent for a second time period to form an aluminum-containing intermediate agent; adding a source of silicon to the aluminum-containing intermediate agent to form an aluminosilicate-containing intermediate agent and homogenizing the aluminosilicate-containing intermediate agent for a third time period to form a synthesis gel (i.e. precursor gel); subjecting the precursor gel to a crystallization process to crystallize a zeolite; and then recovering the solids (e.g., by centrifugation) followed by washing, drying and a high temperature air treatment and subsequent ion-exchange treatments to remove any unreacted reagents or SDA compounds, thereby recovering MFI/TON-type zeolite intergrowth structures.

In at least one specific embodiment, the MFI/TON-type zeolite intergrowth structures can be synthesized by diluting two or more organic structure directing agents (OSDAs) and optionally one or more inorganic structure-directing agents (ISDA) in deionized water and stirring the mixture for 10 minutes. Next, the alumina precursor(s) can be added and stirred vigorously at ambient temperature for 15-60 minutes to ensure complete dissolution of the particles. The silica precursor(s) can be then introduced, and the mixture can be aged under vigorous stirring at ambient temperature for 2-4 hours. The resulting precursor gel solution can be then preheated at a temperature of about 170-175° C. for 5-15 days. The formed crystals can be collected via centrifugation, washed with deionized water, and dried. The dried zeolite powders then optionally can be calcined by dry air.

In one or more embodiments, the MFI/TON-type zeolite intergrowth structures can have a crystallite size of about 0.001 μm to about 10 μm, more preferably about 0.01 μm to about 5 μm. Other crystallite sizes (in microns) can range from a low of about 0.001, about 0.005, or about 0.01 to a high of about 5, about 7.5, or about 10.

In one or more embodiments, the weight ratio of MFI-to-TON phases in the MFI/TON-type zeolite intergrowth structure can be varied such that the average pore size can be tuned between about 0.45 (nanometers) in diameter, which is characteristic of the pores in the TON framework, to about 0.70 nm, which is characteristic of the largest cavity in the MFI framework. In some embodiments, the average pore size can range from a low of about 0.45, 050, or 0.55 nm to a high of about 0.60, 0.65, or 0.70.

In one or more embodiments, the weight percentage of the MFI phase in the MFI/TON-type zeolite intergrowth structure can range from as low as about 1% to as high as about 99%, while the weight percentage of the TON phase in the MFI/TON-type zeolite intergrowth structure can range from as low as about 1% to as high as about 99%. In certain embodiments, the MFI phase in the MFI/TON-type zeolite intergrowth structure can range from a low of about 5, 10, 20, or 30% to a high of about 70, 80, 90, or 95%, the balance being the TON phase.

The Si/Al ratio in the precursor gel can range from a low of about 50 to a high of about 200. For example, the Si/Al ratio in the precursor gel can range from a low of about 50, 60, or 75 to a high of about 140, 175, or 200. The Si/Al ratio in the precursor gel also can range from a low of about 50, 55, or 65 to a high of about 110, 155, or 185.

The amount of the one or more organoammonium compounds per gram of silica can range from a low of about 0.1 gr, 0.2 gr, or 0.3 gr to a high of about 1.0 gr, 1.2 gr, or 1.4 gr. The amount of the one or more organoammonium compounds per gram of silica also can range from a low of about 0.1 gr, 0.2 gr, or 0.3 gr to a high of about 0.8 gr, 0.9 gr, or 1.0 gr.

The amount of the one or more SDAs per gram of silica can range from a low of about 0.1 gr, 0.2 gr, or 0.3 gr to a high of about 1.0 gr, 1.2 gr, or 1.4 gr. The amount of the one or more SDAs per gram of silica also can range from a low of about 0.1 gr, 0.2 gr, or 0.3 gr to a high of about 0.8 gr, 0.9 gr, or 1.0 gr.

In at least one specific embodiment, the MFI/TON-type zeolite intergrowth structures can be synthesized from two or more structure-directing agents (SDAs). For example, the MFI/TON-type zeolite intergrowth structures can be synthesized from diethylamine (DEA) and a source of TPA⁺, such as tetrapropylammonium hydroxide (TPAOH). The molar ratio of the DEA to TPA⁺ can range from 10 to 20 moles of DEA relative to one mole of TPA⁺.

In at least one specific embodiment, the MFI/TON-type zeolite intergrowth structures can be synthesized from two or more structure-directing agents (SDAs). For example, the MFI/TON-type zeolite intergrowth structures can be synthesized from ethylenediamine (EDA) and diethylamine (DEA). The molar ratio of the EDA to DEA can range from 0.5 to 2 moles of EDA relative to DEA.

In any one or more embodiments above or elsewhere herein, the Si:Al ratio can range from a low of about 25, 30, 40 to high of about 100, 200, 300. The Si:Al ratio also can range from a low of about 85, 125, or 165 to a high of about 275, 350, or 400. The Si:Al ratio also can be from 100-400, 15-350, or 200-375.

The source of aluminum can be aluminum hydroxide, aluminum sulfate, aluminum nitrate, aluminosilicate, and any combinations or derivatives thereof.

The source of silicon can be colloidal silica, a silicon alkoxide compound, fumed silica, amorphous silica, aluminosilicate, and any combinations or derivatives thereof.

Each of first, second and third time periods can be the same or different, and each can range from about 1 second to about 48 hours; or about 1 to about 20 hrs; or about 2 to about 10 hrs; or about 3 to about 8 hrs; or about 3 to about 5 hrs; or about 3 to about 4 hrs.

The crystallization process preferably occurs at about 150° C. to about 180° C., but can range from as low of about 100° C., 110° C. or 120° C. to a high of about 180° C., 190° C. or 200° C. The crystallization process can also take place at about 120° C., 130° C., 140° C., 150° C., 160° C., 170° C., or 180° C.

The high temperature air treatment can occur at about 550 to about 700° C. The air treatment but can also range from as low of about 500° C., 510° C., or 520° C. to a high of about 600° C., 650° C. or 00° C.

In one or more embodiments, the MFI/TON-type zeolite intergrowth structures can be combined with another support material. Any suitable support material compatible with zeolites can be used. For example, the support material can have a surface area in the range of from about 10 m²/g to about 700 m²/g, a pore volume in the range of from about 0.1 cc/g to about 4.0 cc/g and an average particle size in the range of from about 0.01 μm to about 0.1 μm. More preferably, the support material can have a surface area in the range of from about 50 m²/g to about 500 m²/g, pore volume of from about 0.5 cc/g to about 3.5 cc/g and average particle size of from about 0.02 μm to about 0.05 μm. The surface area can range from a low of about 50 m²/g, 150 m²/g, or 300 m²/g to a high of about 500 m²/g, 700 m²/g, or 900 m²/g. The surface area also can range from a low of about 200 m²/g, 300 m²/g, or 400 m²/g to a high of about 600 m²/g, 800 m²/g, or 1,000 m²/g. The average pore size of the support material can range of from about 10 Å to 1000 Å, about 50 Å to about 500 Å, about 75 Å to about 350 Å, about 50 Å to about 300 Å, or about 75 Å to about 120 Å.

The amount of structure-directing agents (SDAs) per gram of silica can range from a low of about 0.10 gr, 0.15 gr, 0.30 gr, 0.40 gr, or 0.60 gr to a high of about 0.80 gr, 1.00 gr, 1.50 gr, or 2.00 gr. The SDA/Si ratio can also range from about 0.10 to about 1.90; about 0.15 to about 1.80; about 0.15 to about 1.70; about 0.20 to about 1.65; about 0.50 to about 1.55; and about 0.50 to about 1.65. The SDA/Si ratio can also range from about 1.40 to about 1.50; 1.32 to about 1.48; or about 0.15 to about 1.00.

The amount of Na₂O per gram of silica can range from a low of about 0.005 gr, 0.01 gr, 0.03 gr, 0.05 gr, to a high of about 0.33 gr.

The amount of Al₂O₃ per gram of silica can range from a low of 0.005 gr, 0.01 gr, 0.024 gr, 0.030 gr, 0.045 gr, 0.091 gr to a high of about 0.15 gr. In another embodiment, the Si:Al ratio can range from a low of about 50, 60, 70 or 80 to high of about 100, 150, 200, or 300.

### Oligomerization

The zeolite catalyst, as described herein, can convert one or more light hydrocarbon alkenes to higher molecular weight oligomers. The light hydrocarbons or hydrocarbon feed stream can derive from natural gas, natural gas liquids, or mixtures of both. The hydrocarbon feed stream can be derived directly from shale gas or other formations. The hydrocarbon feed stream can also originate from a refinery, such as from a fluid catalytic cracking (FCC) unit, coker, steam cracker, and pyrolysis gasoline (pygas) as well as alkane dehydrogenation processes, for example, ethane, propane and butane dehydrogenation.

The hydrocarbon feed stream can be or can include one or more olefins having from 2 to 12 carbon atoms. The hydrocarbon feed stream can be or can include one or more linear alpha olefins, such as ethene, propene, butenes, pentenes and/or hexenes. The process is especially applicable to ethene and propene oligomerization for making C4 to about C26 oligomers.

The hydrocarbon feed stream can contain greater than about 65 wt % olefins, such as greater than about 70 wt. % olefins or greater than about 75 wt % olefins. For example, the hydrocarbon feed stream can contain one or more C2 to C12 olefins in amounts ranging from a low of about 50 wt %, 60 wt % or 65 wt % to a high of about 70 wt %, 85 wt % or 100 wt %, based on the total weight of the feed stream. The hydrocarbon feed stream also can include up to 80 mol % alkanes, for example, methane, ethane, propane, butane, and pentane; although the alkane generally comprises less than about 50 mol % of the hydrocarbon feed stream, and preferably less than about 20 mol % of the hydrocarbon stream.

The resulting oligomer(s) can be or can include one or more olefins having from 4 to 26 carbon atoms, such as 12 to 20 carbon atoms, or 16 to 20 carbon atoms. The resulting oligomers, for example, can include butene, hexene, octene, decene, dodecene, tetradecane, hexadecane, octadecene and eicosene and higher olefins, as well as any combinations thereof. The resulting oligomer(s) also can have less than about 5% aromatics and less than about 10 ppm sulfur. The resulting oligomer(s) also can have zero or substantially no aromatics and zero or substantially no sulfur.

The resulting oligomer(s) can be useful as precursors, feedstocks, monomers and/or comonomers for various commercial and industrial uses including polymers, plastics, rubbers, elastomers, as well as chemicals. For example, these resulting oligomer(s) are also useful for making polybutene-1, polyethylene, polypropylene, polyalpha olefins, block copolymers, detergents, alcohols, surfactants, oilfield chemicals, solvents, lubricants, plasticizers, alkyl amines, alkyl succinic anhydrides, waxes, and many other specialty chemicals.

The resulting oligomer(s) can be especially useful for production of diesel and jet fuels, or as a fuel additive. In certain embodiments, the resulting oligomer(s) can have a boiling point in the range of 170° C. to 360° C. and more particularly 200° C. to 300° C. The resulting oligomer(s) also can have a Cetane Index (CI) of 40 to 100 and more particularly 65 to 100. The resulting oligomer(s) also can have a pour point of −50° C. or −40° C.

The oligomerization process can be carried out using any conventional technique. The process can be carried out, for example, in a continuous stirred tank reactor, batch reactor or plug flow reactor. One or more reactors operated in series or parallel can be used. The process can be operated at partial conversion to control the molecular weight of the product and unconverted olefins can be recycled for higher yields.

During oligomerization, the zeolite catalyst can be used alone or can be used with one or more promoters, and/or one or more co-catalysts or activators. The term promoter refers to any metal that can be added to the acid-form zeolite to provide another catalytically active compound, such as nickel. The terms “co-catalyst” and “activator” are used herein interchangeably and refer to any compound, other than the reacting olefin, that can added to the acid-form or metal/acid-form zeolite to further promote the reaction. For example, the following co-catalyst and/or activators can optionally be used: alumoxanes, aluminum alkyls, ionizing activators, which may be neutral or ionic, alumoxane compounds, modified alumoxane compounds, and ionizing anion precursor compounds that abstract one reactive, 6-bound, metal ligand making the metal complex cationic and providing a charge-balancing noncoordinating or weakly coordinating anion. Once the zeolite catalyst is deactivated with high molecular weight carbon, or coke, it can be regenerated using known techniques in the art, including for example, by combustion in air or nitrogen at a temperature of about 400° C. or higher.

### Examples

Embodiments discussed and described herein are further described with the following examples. Numerous MFI/TON-type zeolite intergrowth structures were prepared, according to the procedures of Example 1 and Example 2 to illustrate the effects of crystallization, topology and framework structure. Although the following examples are directed to specific embodiments, they are not to be viewed as limiting in any specific respect.

### Example 1: Crystallization of MFI/TON-Type Zeolite Intergrowth Structures Using Tetrapropylammonium (TPA⁺) and Diethylamine (DEA)

MFI/TON-type zeolite intergrowth structures were synthesized according to the dual-templated method provided herein, using TPA⁺ and DEA as the co-SDAs. To synthesize these zeolites, a synthesis mixture with molar ratios of 1 SiO₂/x Al₂O₃/0.02 TPA⁺/0.29 DEA/15H₂O was prepared and stirred vigorously at ambient conditions for 16 hours, where x was either 1/190 or 1/382. To begin, 1.42 g of DEA (99+%, Thermo Scientific) was added to 11.58 g of D.I. water in a HDPE bottle. Then, 0.677 g of TPAOH (40%, VWR) was added to the solution. The solution was stirred vigorously at room temperature for 15 minutes. 0.0272-0.0547 g of aluminum hydroxide (99+%, SPI Pharma) was added to the solution and stirred for 1 hour at ambient condition until the solution became clear. Then, 10 g of colloidal silica (40%, Ludox AS-40) was added to the solution and the precursor gel was stirred at ambient temperature for 16 hours with the lids closed.

The mixture was transferred to a Teflon-lined stainless-steel autoclave and placed in a preheated forced convection oven at 443-448 K and rotated at 60 rpm for 5 days. The crystals were washed with D.I. water three times, separated by centrifugation, and dried at 373 K in a stagnant air for 24 hours. Organic SDAs were removed by treatment at 973 K (0.0167 K/s) in flowing dry air (1.67 cm³ s⁻¹ g_{zeolite}⁻¹) for 12 hours. Synthesis information is summarized in Table 1.

### Example 2: Crystallization of MFI/TON-Type Zeolite Intergrowth Structures Using Ethylenediamine (EDA) and Diethylamine (DEA)

MFI/TON-type zeolite intergrowth structures were synthesized with the dual-templated method using EDA and DEA. A synthesis mixture with molar ratios of 1 SiO₂/x Al₂O₃/0.25 EDA/0.25 DEA/15H₂O was prepared and stirred vigorously at ambient conditions for 16 hours, where x was 1/47. To begin the synthesis, 1.01 g of EDA (99+%, Thermo Scientific) was added to 11.98 g of D.I. water in a HDPE bottle. Then, 1.22 g of DEA (99+%, Thermo Scientific) was added to the solution. The solution was stirred vigorously at room temperature for 15 minutes. Next, 0.11 g of aluminum hydroxide (99+%, SPI Pharma) was added to the solution and stirred for 1 hour at ambient condition until the solution became clear. Then, 10 g of colloidal silica (40%, Ludox AS-40) was added to the solution and the precursor gel was stirred at ambient temperature for 3 hours with the lids closed.

The mixture was transferred to a Teflon-lined stainless-steel autoclave and placed in a preheated forced convection oven at 443 K and rotated at 60 rpm for 5 days. The crystals were washed with D.I. water three times, separated by centrifugation, and dried at 373 K in a stagnant air for 24 hours. Organic SDAs were removed by treatment at 973 K (0.0167 K/s) in flowing dry air (1.67 cm³ s⁻¹ g_{zeoiite}⁻¹) for 12 hours. Synthesis information and characterization results are summarized in Table 1.

### Example 3: Crystallization of MFI/TON-Type Zeolite Intergrowth Structures Using ethylenediamine (EDA) and Diethylamine (DEA) in the Presence of Sodium Hydroxide and/or potassium Hydroxide

MFI/TON-type zeolite intergrowth structures were synthesized with the dual-templated method using EDA and DEA in the presence of sodium hydroxide and/or potassium hydroxide. A synthesis mixture with molar ratios of 1 SiO₂/x Al₂O₃/0.25 EDA/0.25 DEA/y NaOH/z KOH/15H₂O was prepared and stirred vigorously at ambient conditions for 3 hours, where x was 1/47 or 1/31, y was 0 to 0.03, z was 0 to 0.08, and y+z was 0.02 to 0.08. To begin the synthesis, EDA was added to D.I. water in a HDPE bottle. Then, DEA was added to the solution and stirred vigorously at room temperature for 15 minutes. Next, sodium hydroxide and/or potassium hydroxide were added, followed by the addition of aluminum hydroxide, and the mixture was stirred at ambient conditions until the solution became clear. Then, colloidal silica was added to the solution, and the precursor gel was stirred at ambient temperature for 3 hours with the lids closed.

The mixture was transferred to a Teflon-lined stainless-steel autoclave and placed in a preheated forced convection oven at 443 K and rotated at 60 rpm for 10 days. The crystals were washed with D.I. water three times, separated by centrifugation, and dried at 373 K in stagnant air for 24 hours. Organic SDAs were removed by treatment at 973 K (0.0167 K s−1) in flowing dry air (1.67 cm3 s−1 gzeolite-1) for 12 hours. Under these conditions, MFI/TON-type zeolite intergrowth structures were obtained over a range of alkali-containing gel compositions in which the alkali source comprised sodium hydroxide, potassium hydroxide, or a combination thereof. Synthesis information and characterization results are summarized in Table 1.

TABLE 1
Synthesis and characterization results (including positive and
negative) of MFI/TON-type zeolite intergrowth structures

| Sample # | Si/Al_{gel} | Si | Al | TPA⁺ | EDA | DEA | NaOH | KOH | H₂O |
|---|---|---|---|---|---|---|---|---|---|
| SHK1-9-1-1 | 191 | 1 | 0.005 | 0.02 | 0 | 0.23 | 0 | 0 | 15 |
| SHK1-9-2-1 | 95 | 1 | 0.01 | 0.02 | 0 | 0.23 | 0 | 0 | 15 |
| SHK1-36-1 | 191 | 1 | 0.005 | 0.02 | 0 | 0.29 | 0 | 0 | 15 |
| SHK1-36-2 | 95 | 1 | 0.01 | 0.02 | 0 | 0.29 | 0 | 0 | 15 |
| SHK1-36-3 | 47 | 1 | 0.02 | 0.02 | 0 | 0.29 | 0 | 0 | 15 |
| SHK1-36-4 | 30 | 1 | 0.03 | 0.02 | 0 | 0.29 | 0 | 0 | 15 |
| SHK1-36-5 | 95 | 1 | 0.01 | 0.05 | 0 | 0.25 | 0 | 0 | 15 |
| SHK1-36-6 | 95 | 1 | 0.01 | 0.1 | 0 | 0.2 | 0 | 0 | 15 |
| SHK1-36-7 | 95 | 1 | 0.01 | 0.15 | 0 | 0.15 | 0 | 0 | 15 |
| SHK1-36-8 | 95 | 1 | 0.01 | 0.2 | 0 | 0.1 | 0 | 0 | 15 |
| SHK1-40-1 | 191 | 1 | 0.005 | 0 | 0.1 | 0.4 | 0 | 0 | 15 |
| SHK1-40-2 | 191 | 1 | 0.005 | 0 | 0.2 | 0.3 | 0 | 0 | 15 |
| SHK1-40-3 | 191 | 1 | 0.005 | 0 | 0.25 | 0.25 | 0 | 0 | 15 |
| SHK1-40-4 | 191 | 1 | 0.005 | 0 | 0.3 | 0.2 | 0 | 0 | 15 |
| SHK1-40-5 | 191 | 1 | 0.005 | 0 | 0.4 | 0.1 | 0 | 0 | 15 |
| SHK1-40-6 | 95 | 1 | 0.01 | 0 | 0.25 | 0.25 | 0 | 0 | 15 |
| SHK1-40-7 | 47 | 1 | 0.02 | 0 | 0.25 | 0.25 | 0 | 0 | 15 |
| SHK1-40-8 | 35 | 1 | 0.03 | 0 | 0.25 | 0.25 | 0 | 0 | 15 |
| SHK2-4-1 | 47 | 1 | 0.02 | 0 | 0.25 | 0.25 | 0.02 | 0 | 15 |
| SHK2-4-5 | 47 | 1 | 0.02 | 0 | 0.25 | 0.25 | 0 | 0.02 | 15 |
| SHK2-7-1 | 47 | 1 | 0.02 | 0 | 0.25 | 0.25 | 0.01 | 0.03 | 15 |
| SHK2-7-2 | 47 | 1 | 0.02 | 0 | 0.25 | 0.25 | 0.03 | 0.01 | 15 |
| SHK2-7-3 | 31 | 1 | 0.03 | 0 | 0.25 | 0.25 | 0.02 | 0.05 | 15 |
| SHK2-7-4 | 31 | 1 | 0.03 | 0 | 0.25 | 0.25 | 0 | 0.08 | 15 |

| | | | Temp | Time | | | Yield |
|---|---|---|---|---|---|---|---|
| Sample # | pH_{gel} | pH_{final} | (° C.) | (d) | Topology | Si/Al_{ICP} | (%) |
| SHK1-9-1-1 | — | — | 175 | 5 | MFI/TON | 193 | 65.4 |
| SHK1-9-2-1 | — | — | 175 | 5 | MFI/TON | 96 | 67.6 |
| SHK1-36-1 | 12.89 | 12.19 | 170 | 5 | MFI/TON | 190 | 72.5 |
| SHK1-36-2 | 12.73 | 12.22 | 170 | 5 | MFI/TON | 94 | 67.7 |
| SHK1-36-3 | 12.78 | 12.12 | 170 | 5-14 | No crystal | | |
| SHK1-36-4 | 12.66 | 12.19 | 170 | 5-14 | No crystal | | |
| SHK1-36-5 | 12.96 | 12.26 | 170 | 5 | MFI | | |
| SHK1-36-6 | 13.48 | 12.49 | 170 | 5 | MFI | 110 | |
| SHK1-36-7 | 13.76 | 12.53 | 170 | 5 | MFI | | |
| SHK1-36-8 | 13.95 | 12.54 | 170 | 5 | MFI | | |
| SHK1-40-1 | 12.37 | 12.28 | 170 | 12 | TON | | |
| SHK1-40-2 | 12.28 | 12.24 | 170 | 12 | TON | | |
| SHK1-40-3 | 12.25 | 12.17 | 170 | 12 | TON | | |
| SHK1-40-4 | 12.19 | 11.95 | 170 | 12 | TON | | |
| SHK1-40-5 | 12.06 | 11.94 | 170 | 12 | TON | | |
| SHK1-40-6 | 12.29 | 12.18 | 170 | 12 | TON | | |
| SHK1-40-7 | 12.17 | 12.08 | 170 | 12 | MFI/TON | | |
| SHK1-40-8 | 12.14 | 11.98 | 170 | 12 | Amor | | |
| SHK2-4-1 | 13.05 | 12.25 | 170 | 10 | MFI/TON | 55.8 | |
| SHK2-4-5 | 13.00 | 12.61 | 170 | 10 | MFI/TON | 52.3 | |
| SHK2-7-1 | 13.10 | 12.35 | 170 | 10 | MFI/TON | | |
| SHK2-7-2 | 13.12 | 12.37 | 170 | 10 | MFI/TON | | |
| SHK2-7-3 | 13.42 | 12.76 | 170 | 10 | MFI/TON | | |
| SHK2-7-4 | 13.46 | 12.70 | 170 | 10 | MFI/TON | | |

### Characterization

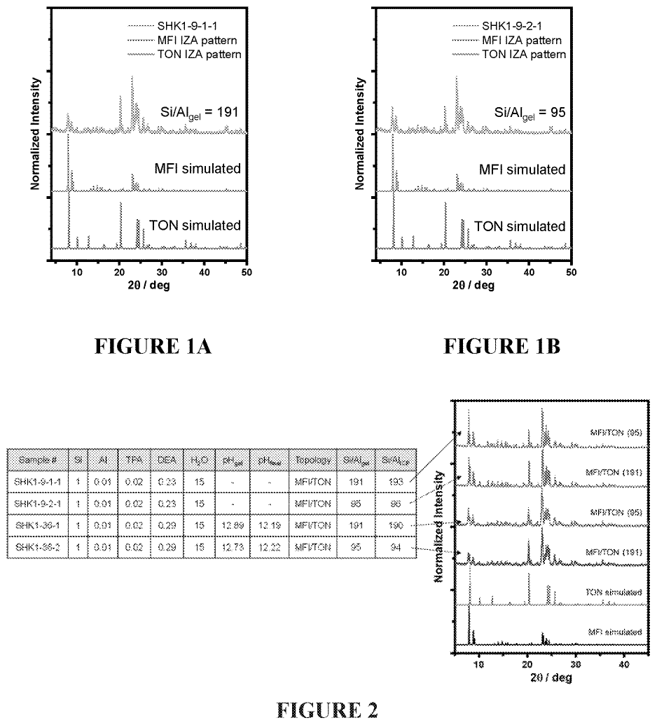

The calcined zeolite samples SHK1-9-1-1 and SHK1-9-2-1, with Si/Al ratios of 191 and 95 in the precursor gel, respectively, were analyzed using powder X-ray diffraction (pXRD), as shown in FIGS. 1A and 1B. The diffractograms for MFI and TON frameworks were simulated using data from the International Zeolite Association (IZA) database. Both samples distinctly exhibited characteristic peaks of the MFI and TON frameworks, confirming the presence of long-range periodic structural features from both frameworks in the samples.

FIGS. 1A and 1B show the powder X-ray Diffraction (pXRD) of SHK1-9-1-1 and SHK1-9-2-1 samples with the MFI and TON framework simulated patterns calculated from International Zeolite Association Database.

FIG. 2 shows the pXRD patterns of four different MFI/TON-type zeolite intergrowth structure samples (SHlK1-9-1-1, SHK1-9-2-1, SHlK1-36-1, and SHlK1-36-2) synthesized with varying precursor gel compositions. MFI and TON simulated patterns are shown in grey scale, calculated from International Zeolite Association Database. The simulated diffraction patterns for MFI and TON frameworks are also included for comparison. All samples displayed characteristic peaks of both MFI and TON frameworks, further confirming that the synthesized materials possess long-range periodic structural features of the MFI/TON-type zeolite intergrowth structure.

FIG. 3 shows the pXRD patterns of samples synthesized with different DEA/TPA⁺ ratios, ranging from 0.5 to 14.5. In particular, FIG. 3 shows the pXRD patterns of six different MFI/TON intergrowth structure samples (SHK1-36-8, SHK1-36-7, SHK1-36-6, SHK1-36-5, SHK1-9-2-1, and SHK1-36-2) synthesized with different DEA/TPA⁺ ratios, ranging from 0.5 to 14.5. Magnified pattern of the long-range order is shown on the left. α refers to the MFI characteristic peak and p refers to the TON characteristic peak. When the DEA/TPA⁺ ratio was less than or equal to 5, only MFI frameworks crystallized after 5 days of dynamic synthesis at 170° C. However, when the DEA amount was at least an order of magnitude higher than TPA⁺, both MFI and TON features appeared. These results provide insight into the synthesis criteria necessary to achieve MFI/TON-type zeolite intergrowth structures.

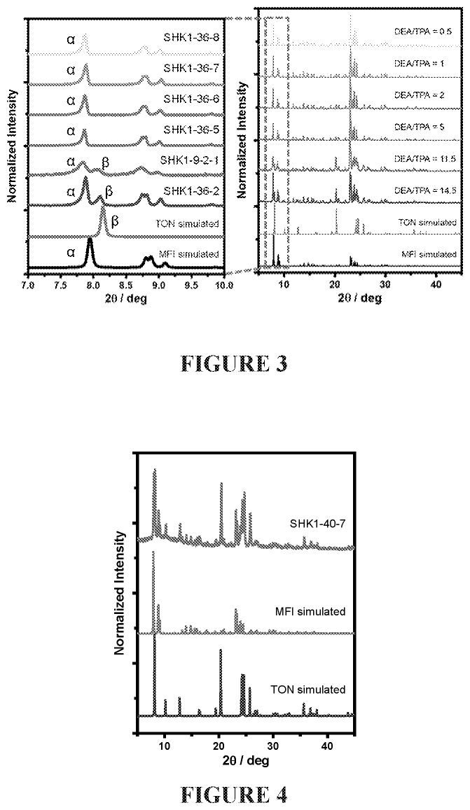

FIG. 4 shows the Powder X-ray diffraction pattern of the calcined zeolite sample SHK1-40-7 that was synthesized with EDA and DEA and a precursor gel Si/Al ratio of 47, according to the procedure in Example 2. MFI and TON simulated patterns are shown in gray scale. The diffraction pattern of SHK1-40-7 revealed characteristic peaks corresponding to both MFI and TON frameworks. This result indicates that SHK1-40-7 is also a form of the MFI/TON-type zeolite intergrowth structure, possessing the periodic structural features of both frameworks.

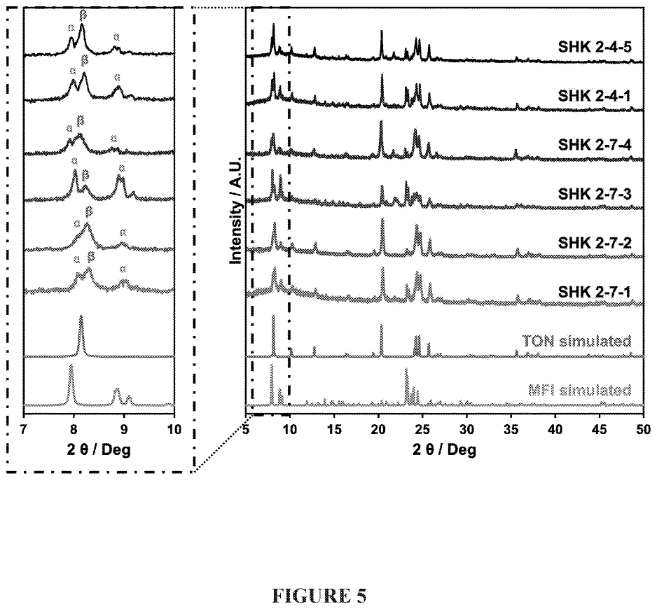

FIG. 5 shows the PXRD patterns of samples synthesized with the same EDA/DEA ratios in the presence of different sodium and potassium environments. In particular, FIG. 5 shows the PXRD patterns of six MFI/TON-type zeolite intergrowth structure samples (SHK2-4-1, SHK2-4-5, SHK2-7-1, SHK2-7-2, SHK2-7-3, and SHK2-7-4) prepared with EDA and DEA as co-SDAs and with varying amounts of sodium hydroxide and potassium hydroxide. The total alkali content ranged from 0.02 to 0.08 on a molar basis relative to SiO₂. An enlarged view of the long-range order region is shown on the left, where a denotes an MFI-characteristic peak, and R denotes a TON-characteristic peak. Across these synthesis conditions, diffraction features assigned to both MFI and TON frameworks were observed, consistent with the formation of MFI/TON-type zeolite intergrowth structures. These results show that MFI/TON-type zeolite intergrowth structures can be crystallized in the EDA/DEA system over a range of sodium hydroxide, potassium hydroxide, and mixed sodium hydroxide/potassium hydroxide conditions.

To further elucidate the identity of the synthesized samples, the SHK1-9-1-1 sample was selected for analysis using scanning electron microscopy (SEM). SEM images were collected with an Apreo 2 SEM instrument equipped with an Everhart-Thornley Detector, operating at 5.0 kV voltage and 0.4 nA beam current, with a working distance of 10 mm.

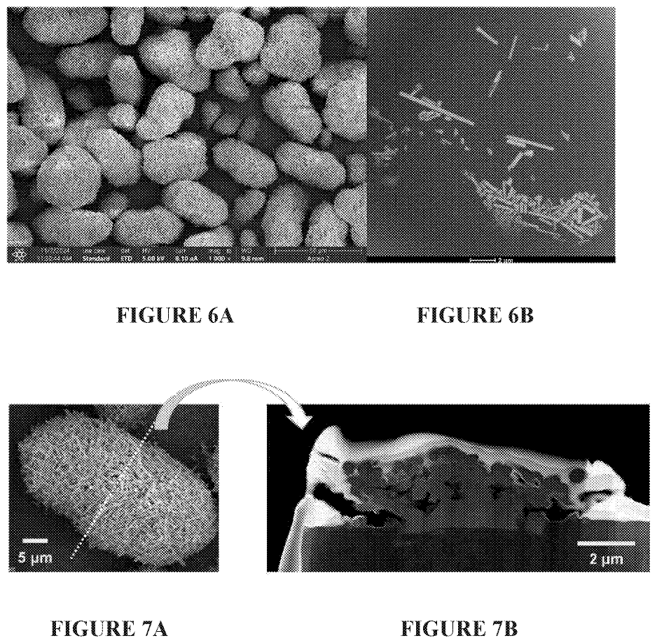

FIG. 6A illustrates the scanning electron microscope (SEM) image of the calcined SHK1-9-1-1 sample with precursor gel Si/Al ratio of 191 from tetrapropylammonium (TPA⁺) and diethylamine (DEA). FIG. 6B shows the transmission electron microscopy (TEM) image of the sonicated SHK1-9-1-1 sample. As depicted in FIG. 5A, the SEM image of the calcined SHK1-9-1-1 sample reveals the agglomerated needle-like morphology of the crystals. To investigate whether these needles were individual crystals or aggregates, 10 mg of the calcined sample was dispersed in 10 mL of ethanol and sonicated for 90 minutes. The resulting transmission electron microscopy (TEM) image of the sonicated sample, shown in FIG. 5B, confirms that the crystals exhibit a long, high aspect-ratio needle morphology. This observation excludes the hypothesis of a physical mixture or co-crystallization of MFI and TON frameworks.

To further investigate the crystal morphology and internal structure, a focused ion beam (FIB) was employed to cut the calcined SHK1-9-1-1 sample, allowing cross-sectional imaging. FIG. 7A shows the SEM image of the SHK1-9-1-1 sample (left), and FIG. 7B shows the focused ion-beam (FIB) cross-sectional image of the same SHK1-9-1-1 sample (right). The FIB-SEM image is of the cross-section of the sample mounted on carbon tape. The bright outer layer corresponds to the platinum coating applied during sample preparation, while the thick gray layer at the bottom represents the carbon tape substrate.

The cross-sectional image reveals that the agglomerated crystals are small, needle-like crystals with high aspect ratios. This observation aligns with the earlier SEM and TEM analyses, providing further evidence of the structural integrity and morphology of the synthesized SHK1-9-1-1 sample.

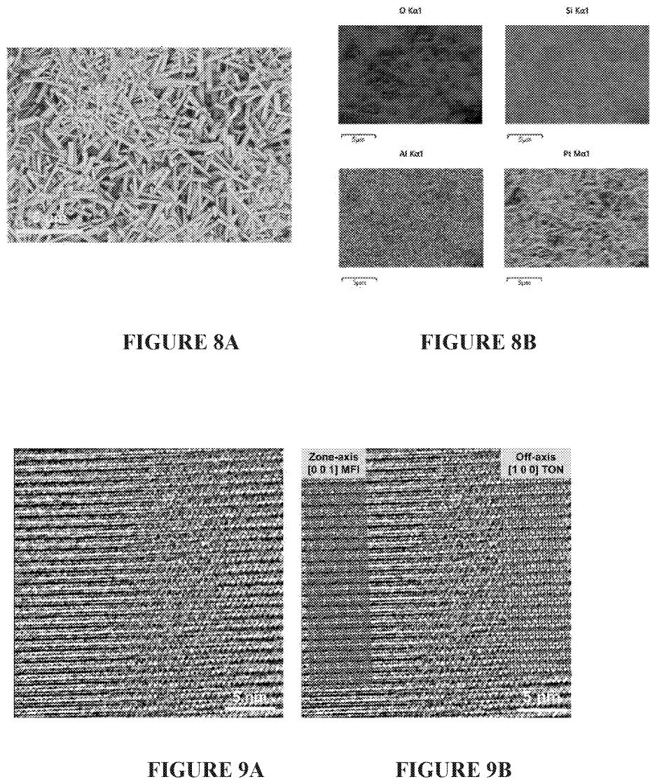

FIG. 8A shows the SEM image of the SHK1-9-1-1 sample (left) and FIG. 8B shows the electron diffraction spectroscopy (EDS) analysis of oxygen, silicon, aluminum and platinum (platinum was sputtered before measuring the microscopy image) of the same region (right). FIGS. 8A and 8B are provided to further illustrate the presence of intergrowth in the synthesized material. If MFI and TON frameworks were co-crystallized as a physical mixture, the differing populations of charged OSDA (TPA⁺) and uncharged OSDA (DEA) would likely lead to non-homogeneous distribution of aluminum (Al) atoms. However, as shown in FIG. 7B, the Al atoms are nearly homogeneously distributed across the sample. This finding supports the hypothesis that the material is MFI/TON-type zeolite intergrowth structure rather than a physical mixture of the two crystal phases.

To further confirm and visualize the MFI/TON-type zeolite intergrowth structure, high-resolution imaging was conducted using a Cs-corrected FEI Themis Z instrument to obtain high-angle annular dark-field (HAADF) STEM and integrated differential phase contrast (iDPC) images. FIG. 9A shows the integrated differential phase contrast (iDPC) scanning transmission electron microscopy (STEM) image of the calcined SHK1-9-1-1 sample. The image, captured from a single crystal, shows clear evidence of structural stacking faults or intergrowth, as indicated by lattice distortions. Detailed analysis reveals that the left side of the image corresponds to the zone-axis view of MFI along [0 0 1], while the right side corresponds to the off-axis view of TON along [1 0 0]. Notably, the [1 0 0] plane of MFI (where sinusoidal channels are present) aligns perfectly with the [0 0 1] plane of TON (where one-dimensional straight channels dominate).

FIG. 9B shows the iDPC STEM image of MFI and TON structure overlaid with superimposed MFI and TON structures for clearer visualization. This image offers direct evidence of the MFI/TON-type zeolite intergrowth structure formed from the given synthesis conditions.

Further characterization was conducted using Electron Microscopy (EM) for the MFI/TON-type zeolite intergrowth structures synthesized from ethylenediamine (EDA) and diethylamine (DEA). The SHK1-42-7 sample was selected for scanning electron microscopy (SEM) analysis. Using the same parameters as previously described, FIG. 9 shows the SEM image of the calcined SHK1-42-7 sample.

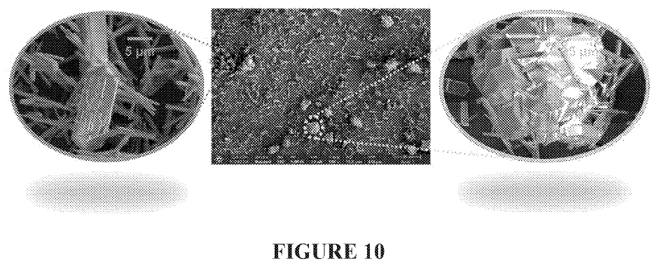

As depicted in FIG. 10, the morphology of the SHK1-42-7 sample differs significantly from that of SHK1-9-1-1 (shown in FIG. 7A), which was synthesized using TPA⁺ and DEA. The SHK1-42-7 sample exhibited a spread of needle-shaped crystals interspersed with sporadically attached coffin-shaped crystals. According to the literature, needle-shaped crystals are characteristic of the TON framework, while coffin-shaped crystals are indicative of the MFI framework.

Interestingly, the SEM images reveal interfaces where needle-shaped TON crystals are directly connected to coffin-shaped MFI crystals. This suggests that the surfaces of the two crystal types are compatible enough to allow the TON framework to grow on one side and the MFI framework on the other. These observations strongly support the presence of the MFI/TON-type zeolite intergrowth structure in the SHK1-42-7 sample.

The MFI/TON-type zeolite intergrowth structure provides several key advantages over existing zeolite materials and synthetic methods. For example, by controlling the ratio and arrangement of MFI to TON domains, one can optimize transport paths within the crystal. This can alleviate the intrazeolite diffusion barriers in the channel network, allowing for the formation and egress of heavy oligomer products. Second, the intergrowth structure can balance the kinetic and thermodynamic factors that influence catalysis. Tailoring the pore architecture allows for more selective formation of target products, while minimizing side reactions that shorten catalyst life.

Third, the dual co-templating method offers a generalizable strategy that can be extended to other framework combinations. By modulating synthetic parameters, it is possible to induce intergrowth in previously incompatible systems, thereby expanding the library of complex, multifunctional zeolitic materials.

Other specific embodiments include any of the Embodiments numbered 1 through 23, as follows:
Embodiment 1: A precursor gel for making MFI/TON-type zeolite intergrowth structures, comprising: two or more structure-directing agent (SDAs) selected from the group consisting of ethylenediamine (EDA), diethylamine (DEA), tetrapropylammonium (TPA⁺), n-propylamine (NPAM), 1,4-diaminobutane (DAB), 1,6-diaminohexane (DAH), and combinations thereof, optionally, sodium cations (Na⁺); optionally, potassium cations (K⁺); a source of silicon (Si); and a source of aluminum (Al).
Embodiment 2: The precursor gel of embodiment 1, wherein the two or more structure-directing agents (SDAs) consist of diethylamine (DEA) and tetrapropylammonium (TPA).
Embodiment 3: The precursor gel of embodiment 2, wherein the molar ratio of the DEA-to-TPA⁺ can range from 10-to-1 to 20-to-1.
Embodiment 4: The precursor gel of any embodiment 1 to 3, wherein the two or more structure-directing agents (SDAs) consist of ethylenediamine (EDA) and diethylamine (DEA).
Embodiment 5: The precursor gel of embodiment 4, wherein the molar ratio of the EDA-to-DEA ranges from 0.5-to-1 to 2-to-1.
Embodiment 6: The precursor gel of any embodiment 1 to 5, wherein the source of aluminum is selected from the group consisting of aluminum hydroxide, aluminum sulfate, aluminum nitrate, aluminosilicate, and combinations or derivatives thereof.
Embodiment 7: The precursor gel of any embodiment 1 to 6, wherein the source of silica is selected from the group consisting of colloidal silica, a silicon alkoxide compound, fumed silica, amorphous silica, aluminosilicate, and any combinations or derivatives thereof.
Embodiment 8: An MFI/TON-type zeolite intergrowth structure made from an aluminosilicate gel comprising: two or more structure-directing agent (SDAs) selected from the group consisting of ethylenediamine (EDA), diethylamine (DEA), tetrapropylammonium (TPA⁺), n-propylamine (NPAM), 1,4-diaminobutane (DAB), 1,6-diaminohexane (DAH), and combinations thereof, optionally, sodium cations (Na⁺); optionally, potassium cations (K⁺); a source of silicon (Si); and a source of aluminum (Al).
Embodiment 9: The zeolite framework of embodiment 8, wherein the two or more structure-directing agent (SDAs) consist of diethylamine (DEA) and tetrapropylammonium (TPA).
Embodiment 10: The zeolite framework of embodiment 9 wherein the molar ratio of the DEA-to-TPA⁺ can range from 10-to-1 to 20-to-1.
Embodiment 11: The zeolite framework of embodiments 8 to 10, wherein the two or more structure-directing agent (SDAs) consist of ethylenediamine (EDA) and diethylamine (DEA).
Embodiment 12: The zeolite framework of embodiment 11, wherein the molar ratio of the EDA-to-DEA ranges from 0.5-to-1 to 2-to-1.
Embodiment 13: The zeolite framework of any embodiment 8 to 12, wherein the Si:Al ratio ranges from about 25 to about 300.
Embodiment 14: The zeolite framework of any embodiment 8 to 13, wherein the source of aluminum is selected from the group consisting of aluminum hydroxide, aluminum sulfate, aluminum nitrate, aluminosilicate, and combinations or derivatives thereof.
Embodiment 15: The zeolite framework of any embodiment 8 to 14, wherein the source of silica is selected from the group consisting of colloidal silica, a silicon alkoxide compound, fumed silica, amorphous silica, aluminosilicate, and any combinations or derivatives thereof.
Embodiment 16: A method for synthesizing MFI/TON-type zeolite intergrowth structures, comprising: preparing an aqueous solution comprising two or more structure directing agents selected from the group consisting of ethylenediamine (EDA), diethylamine (DEA), tetrapropylammonium (TPA), n-propylamine (NPAM), 1,4-diaminobutane (DAB), 1,6-diaminohexane (DAH), and combinations thereof, mixing the aqueous solution with at least one silicon precursor and at least one aluminum precursor to provide a precursor gel; and recovering MFI/TON-type zeolite intergrowth structures from the precursor gel, wherein the MFI/TON-type zeolite intergrowth structures are crystalline solids having a crystallite size of about 0.001 μm to about 10 μm.
Embodiment 17: The method of embodiment 16, wherein the two or more structure-directing agents (SDAs) consist of diethylamine (DEA) and tetrapropylammonium (TPA⁺), and wherein the molar ratio of the DEA-to-TPA⁺ can range from 10-to-1 to 20-to-1.
Embodiment 18: The method of embodiment 16, wherein the two or more structure-directing agents (SDAs) consist of ethylenediamine (EDA) and diethylamine (DEA), and wherein the molar ratio of the EDA-to-DEA ranges from 0.5-to-1 to 2-to-1.
Embodiment 19: The method of any embodiment 16 to 18, wherein the crystalline solids have an average pore size of about 0.45 nm to 0.70 nm.
Embodiment 20: The method of any embodiment 16 to 19, wherein the crystalline solids contain about 1 wt % to about 99 wt % of an MFI phase and about 99 wt % to 1 about wt % of a TON phase.
Embodiment 21: In any of the foregoing embodiments 1 to 20, wherein the Si:Al ratio ranges from about 25 to about 300.
Embodiment 22: In any of the foregoing embodiments 1 to 21, wherein the precursor gel comprises sodium cations (Na⁺).
Embodiment 23: In any of the foregoing embodiments 1 to 21, wherein the precursor gel comprises potassium cations (K⁺).

In the above detailed description, the specific embodiments of this disclosure have been described in connection with its preferred embodiments. However, to the extent that the above description is specific to a particular embodiment or a particular use of this disclosure, this is intended to be illustrative only and merely provides a concise description of the exemplary embodiments. Accordingly, the disclosure is not limited to the specific embodiments described above, but rather, the disclosure includes all alternatives, modifications, and equivalents falling within the true scope of the appended claims. Various modifications and variations of this disclosure will be obvious to a worker skilled in the art and it is to be understood that such modifications and variations are to be included within the purview of this application and the spirit and scope of the claims.

All patents and patent applications, test procedures (such as ASTM methods, UL methods, and the like), and other documents cited herein are fully incorporated by reference to the extent such disclosure is not inconsistent with this disclosure and for all jurisdictions in which such incorporation is permitted.

Certain embodiments and features have been described using a set of numerical upper limits and a set of numerical lower limits. It should be appreciated that ranges including the combination of any two values, e.g., the combination of any lower value with any upper value, the combination of any two lower values, and/or the combination of any two upper values are contemplated unless otherwise indicated. Certain lower limits, upper limits and ranges appear in one or more claims below. All numerical values are “about” or “approximately” the indicated value, meaning the values take into account experimental error, machine tolerances and other variations that would be expected by a person having ordinary skill in the art.

The foregoing has also outlined features of several embodiments so that those skilled in the art can better understand the present disclosure. Those skilled in the art should appreciate that they can readily use the present disclosure as a basis for designing or modifying other methods or devices for carrying out the same purposes and/or achieving the same advantages of the embodiments disclosed herein. Those skilled in the art should also realize that such equivalent constructions do not depart from the spirit and scope of the present disclosure, and that they can make various changes, substitutions, and alterations herein without departing from the spirit and scope of the present disclosure, and the scope thereof is determined by the claims that follow.

Various terms have been defined above. To the extent a term used in a claim is not defined above, it should be given the broadest definition persons in the pertinent art have given that term as reflected in at least one printed publication or issued patent. Furthermore, all patents, test procedures, and other documents cited in this application are fully incorporated by reference to the extent such disclosure is not inconsistent with this application and for all jurisdictions in which such incorporation is permitted.

While the foregoing is directed to embodiments of the present invention, other and further embodiments of the invention may be devised without departing from the basic scope thereof, and the scope thereof is determined by the claims that follow.

What is claimed is:

1. A precursor gel for making MFI/TON-type zeolite intergrowth structures, comprising:
two or more structure-directing agent (SDAs) selected from the group consisting of ethylenediamine (EDA), diethylamine (DEA), tetrapropylammonium (TPA⁺), n-propylamine (NPAM), 1,4-diaminobutane (DAB), 1,6-diaminohexane (DAH), and combinations thereof,
optionally, sodium cations (Na⁺);
optionally, potassium cations (K⁺);
a source of silicon (Si); and
a source of aluminum (Al).

2. The precursor gel of claim 1, wherein the two or more structure-directing agent (SDAs) consist of diethylamine (DEA) and tetrapropylammonium (TPA⁺).

3. The precursor gel of claim 2, wherein the molar ratio of the DEA-to-TPA⁺ can range from 10-to-1 to 20-to-1.

4. The precursor gel of claim 1, wherein the two or more structure-directing agent (SDAs) consist of ethylenediamine (EDA) and diethylamine (DEA).

5. The precursor gel of claim 4, wherein the molar ratio of the EDA-to-DEA ranges from 0.5-to-1 to 2-to-1.

6. The precursor gel of claim 1, wherein the source of aluminum is selected from the group consisting of aluminum hydroxide, aluminum sulfate, aluminum nitrate, aluminosilicate, and combinations or derivatives thereof.

7. The precursor gel of claim 1, wherein the source of silica is selected from the group consisting of colloidal silica, a silicon alkoxide compound, fumed silica, amorphous silica, aluminosilicate, and any combinations or derivatives thereof.

8. An MFI/TON-type zeolite intergrowth structure made from an aluminosilicate gel comprising:
two or more structure-directing agent (SDAs) selected from the group consisting of ethylenediamine (EDA), diethylamine (DEA), tetrapropylammonium (TPA⁺), n-propylamine (NPAM), 1,4-diaminobutane (DAB), 1,6-diaminohexane (DAH), and combinations thereof,
optionally, sodium cations (Na⁺);
optionally, potassium cations (K⁺);
a source of silicon (Si); and
a source of aluminum (Al).

9. The zeolite framework of claim 8, wherein the two or more structure-directing agents (SDAs) consist of diethylamine (DEA) and tetrapropylammonium (TPA).

10. The zeolite framework of claim 9 wherein the molar ratio of the DEA-to-TPA⁺ can range from 10-to-1 to 20-to-1.

11. The zeolite framework of claim 8, wherein the two or more structure-directing agent (SDAs) consists of ethylenediamine (EDA) and diethylamine (DEA).

12. The zeolite framework of claim 11, wherein the molar ratio of the EDA-to-DEA ranges from 0.5-to-1 to 2-to-1.

13. The zeolite framework of claim 8, wherein the Si:Al ratio ranges from about 25 to about 300.

14. The zeolite framework of claim 8, wherein the source of aluminum is selected from the group consisting of aluminum hydroxide, aluminum sulfate, aluminum nitrate, aluminosilicate, and combinations or derivatives thereof.

15. The zeolite framework of claim 8, wherein the source of silica is selected from the group consisting of colloidal silica, a silicon alkoxide compound, fumed silica, amorphous silica, aluminosilicate, and any combinations or derivatives thereof.

16. A method for synthesizing MFI/TON-type zeolite intergrowth structures, comprising:
preparing an aqueous solution comprising two or more structure directing agents selected from the group consisting of ethylenediamine (EDA), diethylamine (DEA), tetrapropylammonium (TPA⁺), n-propylamine (NPAM), 1,4-diaminobutane (DAB), 1,6-diaminohexane (DAH), and combinations thereof,
mixing the aqueous solution with at least one silicon precursor and at least one aluminum precursor to provide a precursor gel; and
recovering MFI/TON-type zeolite intergrowth structures from the precursor gel, wherein the MFI/TON-type zeolite intergrowth structures are crystalline solids having a crystallite size of about 0.001 μm to about 10 μm.

17. The method of claim 16, wherein the two or more structure-directing agent (SDAs) consist of diethylamine (DEA) and tetrapropylammonium (TPA), and wherein the molar ratio of the DEA-to-TPA⁺ can range from 10-to-1 to 20-to-1.

18. The method of claim 16, wherein the two or more structure-directing agent (SDAs) consists of ethylenediamine (EDA) and diethylamine (DEA), and wherein the molar ratio of the EDA-to-DEA ranges from 0.5-to-1 to 2-to-1.

19. The method of claim 16, wherein the crystalline solids have an average pore size of about 0.45 nm to 0.70 nm.

20. The method of claim 16, wherein the crystalline solids contain about 1 wt % to about 99 wt % of an MFI phase and about 99 wt % to 1 about wt % of a TON phase.
